(19) United States
(12) Patent Application Publication
(10) Pub. No.: US 2021/0184920 A1
(43) Pub. Date: Jun. 17, 2021

(54) COMMUNICATION SYSTEM, COMMUNICATION DEVICE, AND RECORDING MEDIUM

(71) Applicant: Mitsubishi Electric Corporation, Tokyo (JP)

(72) Inventors: Satoshi ARAKAWA, Tokyo (JP); Hiroaki OMI, Nagoya-shi, Aichi (JP)

(73) Assignee: Mitsubishi Electric Corporation, Tokyo (JP)

(21) Appl. No.: 17/270,440

(22) PCT Filed: Oct. 29, 2018
(86) PCT No.: PCT/JP2018/040080

§ 371 Date: Feb. 23, 2021

(51) Int. Cl. H04L 12/24

(52) U.S. Cl. CPC H04L 41/0654; H04L 41/0816

(57) ABSTRACT

A master-slave communication system (1) includes communication devices (100A to 100D) each operable as a master or a slave. Each of at least two (100A to 100C) of the communication devices that operates as slaves includes a down-state detection period storage (120) that stores a down-state detection period set shorter for a slave with a higher priority in selecting a new master among the slaves. A master presence determiner (140) determines whether a master is present based on whether the communication device receives, after receiving a signal from a master and before the down-state detection period elapses, a new signal from a communication device operating as a master. An operation switch (160) switches an operation of the communication device to an operation as a master when the master presence determiner (140) determines that a master is absent.

### TECHNICAL FIELD

The present disclosure relates to a communication system, a communication device, a method, and a program.

### BACKGROUND ART

In a master-slave communication system, a communication device serving as a master may malfunction and fail to operate as a master. In such a case, one of the communication devices operating as slaves in the system may be newly selected to operate as a master.

Patent Literature 1 describes a system in which communication devices operating as slaves determine that a master is absent when not receiving, for a predetermined period, a master notification frame to be issued at predetermined intervals from a communication device operating as a master. In the system described in Patent Literature 1, a communication device operating as a slave switches to a master when determining that a master is absent, and then broadcasts master notification frames to the another communication devices.

In this configuration, multiple communication devices serving as slaves may switch to masters. The configuration described in Patent Literature 1 thus uses control to avoid collisions described below. Each communication device has an assigned priority in switching to a master. When a communication device switched to a master receives a master notification frame from another communication device, the communication device as a master compares the assigned priority with the priority tagged to the received master notification frame. When the priority is lower than the priority tagged to the received master notification frame, the communication device switches back to a slave. When the priority is higher than the priority tagged to the received master notification frame, the communication device transmits a response frame to the communication device that has transmitted the master notification frame and continues to operate as a master. The transmission of master notification frames and the comparison between the priorities of multiple communication devices are repeated until a single master operates.

### CITATION LIST

### Patent Literature

Patent Literature 1: Unexamined Japanese Patent Application Publication No. 9-149061

### SUMMARY OF INVENTION

### Technical Problem

In the configuration described in Patent Literature 1, the transmission of master notification frames and the comparison between the priorities of multiple communication devices are to be repeated until a single master operates. The configuration with many slaves can take a longer time before a single master is selected.

In response to the above issue, an objective of the present disclosure is to shorten the time taken to select a new master in a master-slave communication system when a master is absent.

### Solution to Problem

To achieve the above objective, a master-slave communication system according to an aspect of the present disclosure includes communication devices each operable as a master or a slave. Each of at least two of the communication devices that operate as slaves includes detection period storage means, master presence determination means, and operation switching means. The detection period storage means stores a down-state detection period set shorter for a slave with a higher priority in selecting a new master among the slaves. The master presence determination means determines whether a master is present based on whether the communication device receives, after receiving a signal from a master and before the down-state detection period elapses, a new signal from a communication device that operates as a master. The operation switching means switches an operation of the communication device to an operation as a master when the master presence determination means determines that a master is absent.

### Advantageous Effects of Invention

In the communication system according to the above aspect of the present disclosure, each of the communication devices operating as slaves determines whether a master is present based on whether the communication device receives, after receiving a signal from a master and before the down-state detection period elapses, a new signal from a communication device operating as a master. The down-state detection period is set shorter for a communication device with a higher priority in selecting a new master. The communication system according to the above aspect of the present disclosure with the above configuration allows a communication device operating as a slave with a higher priority in selecting a master than other communication devices operating as slaves to detect the absence of a master before the another communication devices detect the absence and then to switch to a master. In this system, a communication device with a lower priority does not transmit the frame with the priority, thus shortening the time taken to select a new master.

### BRIEF DESCRIPTION OF DRAWINGS

FIG. 1 is a block diagram of a communication system according an embodiment;

FIG. 2 is a block diagram of a communication device according to the embodiment showing the hardware configuration;

FIG. 3 is a flowchart of an arbitration procedure performed when a master is absent in the embodiment;

FIG. 4 is a flowchart of an arbitration procedure performed when an arbitration frame is received in the embodiment;

FIG. 5 is a diagram showing timings for transmission and reception of arbitration frames in the arbitration procedure in the embodiment;

FIG. 6 is a diagram showing other timings for transmission and reception of arbitration frames in the arbitration procedure in the embodiment;

FIG. 7 is a block diagram of a communication system according to Modification 2; and

FIG. 8 is a block diagram of a communication device other than candidates for a master according to Modification 2 showing the hardware configuration.

### DESCRIPTION OF EMBODIMENTS

### Embodiment

A communication system according to an embodiment of the present disclosure will now be described in detail with reference to the drawings.

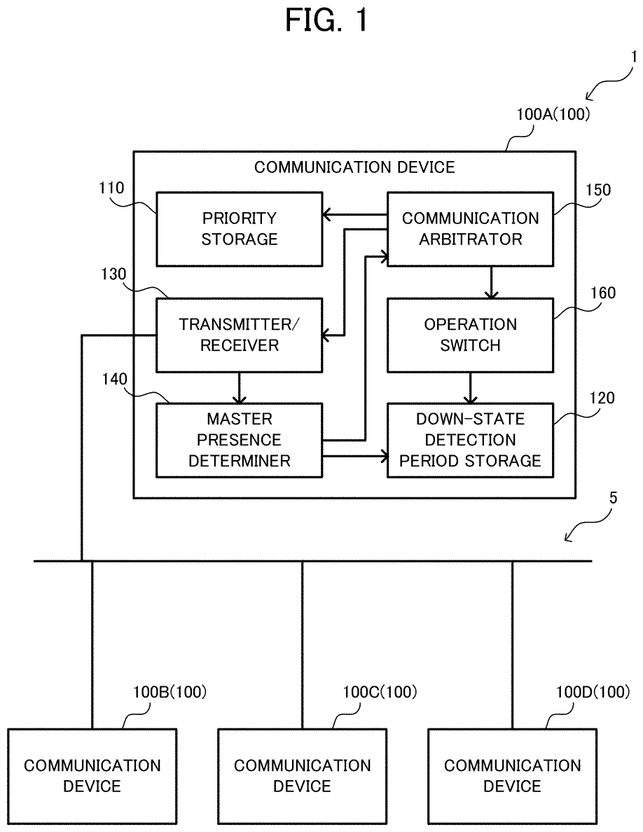

As shown in FIG. 1, a communication system 1 includes communication devices 100A to 100D that are connected to one another through a network 5. The communication devices 100A to 100D may be hereafter collectively referred to as communication devices 100. The communication devices 100A to 100D are, for example, programmable logic controllers operating in, for example, a production system and a control system. The communication devices 100A to 100D transmit and receive data collected from sensors managed by the respective communication device to and from one another. In the communication system 1, the multiple communication devices 100 communicate with one another based on a master-slave scheme. The network 5 is a network that complies with, for example, the 100BASE-T standard.

In the communication system 1, one of the communication devices 100A to 100D operates as a master and the other communication devices operate as slaves. The communication device 100 operating as a master manages timings for data transmission and reception. The communication devices 100 operating as slaves transmit and receive data as managed by the master. In this manner, the communication devices 100A to 100D perform synchronous communication.

The communication device 100 operating as a master broadcasts a master notification frame to the communication devices 100 operating as slaves at predetermined intervals to notify the presence of a master to the devices. The communication devices 100 operating as slaves each determine whether a master is present based on whether a master notification frame has been received. A master notification frame includes, for example, information identifying the communication device 100 operating as a master. Hereafter, the communication device 100 operating as a master may be simply referred to as a master. Each communication device 100 operating as a slave may be simply referred to as a slave.

In the communication system 1, when the master cannot operate as a master due to a malfunction or for any other reason, slaves adjust with one another to select a new master. The adjustment between slaves to select a new master is hereafter referred to as communication arbitration or simply arbitration. Slaves transmit and receive frames called arbitration frames for communication arbitration to and from one another. In the embodiment, each slave has a preassigned priority in selecting a master. When a master is absent, a slave with the highest priority is selected as a new master. Each arbitration frame is tagged with the priority of a slave that has transmitted the arbitration frame. A slave that has received an arbitration frame compares the preassigned priority with the priority tagged to the arbitration frame and determines whether the device is to switch to a master.

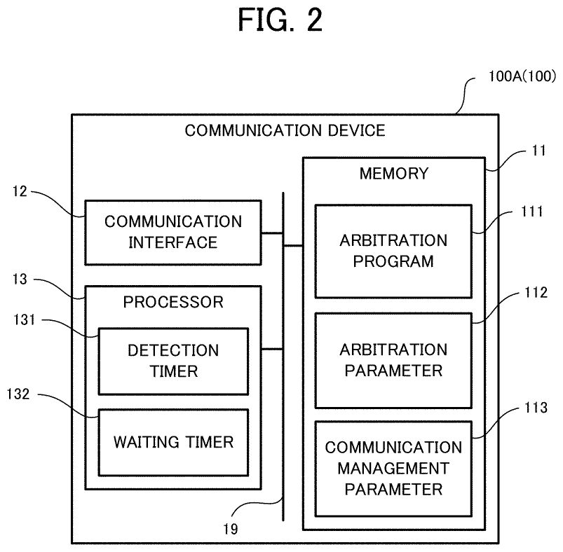

As shown in FIG. 2, the communication device 100A includes hardware components including a memory 11 for storing various programs and various data items, a communication interface 12 for communicating with other communication devices 100, and a processor 13 for controlling the entire communication device 100. The memory 11 and the communication interface 12 are connected to the processor 13 with a bus 19 and communicate with the processor 13. The communication devices 100B to 100D also have the same configuration as the communication device 100A described in the embodiment.

The memory 11 includes a volatile memory and a nonvolatile memory.

The memory 11 stores an arbitration program 111 for communication arbitration between communication devices 100, arbitration parameters 112 used for communication arbitration, and communication management parameters 113 used to manage slaves when the communication device 100A operates as a master. The arbitration program 111, the arbitration parameters 112, and the communication management parameters 113 are prestored in the memory 11 by a user that manages the communication system 1 using a setting tool (not shown). The memory 11 is also used as a work memory for the processor 13. The arbitration program 111 is an example of a program according to the present disclosure.

The arbitration program 111 is executed by the processor 13. The processor 13 executes the arbitration program 111 to determine whether a master is absent. When a master is absent, the processor 13 implements the function to perform communication arbitration with other communication devices 100.

The arbitration parameters 112 are used when the processor 13 executes the arbitration program 111. The arbitration parameters 112 include a priority in selecting the communication device 100A as a master, a down-state detection period for the communication device 100A to detect the absence of a master, and a waiting period indicating the period for the communication device 100A to wait during communication arbitration. The priority indicates the order in which the communication device 100A is to be selected as a new master when a master is absent.

The down-state detection period is a period during which the communication device 100A detects a down-state of a master. The communication device 100A determines that a master is absent when receiving no master notification frame from a master for a predetermined period. The predetermined period is the down-state detection period. The down-state detection period is set longer than the interval at which a master transmits a master notification frame. The waiting period is a period during which the communication device 100A is to wait before switching to a master when a master is absent. When determining that a master is absent, the communication device 100A first transmits arbitration frames to other communication devices 100, and then switches to a master after the waiting period has elapsed. The waiting period is set shorter for a communication device 100A with a higher priority.

The communication management parameters 113 are parameters used by the communication device 100A to manage the entire network 5 when operating as a master. After switching to a master, the communication device 100A uses the communication management parameters 113 to manage the entire network 5.

The communication interface 12 includes a network interface circuit for communicating with other devices. The communication interface 12 communicates with other communication devices 100 as controlled by the processor 13. The communication interface 12 converts data provided by the processor 13 into an electric signal and transmits the resultant signal to other communication devices 100 through the network 5. Additionally, the communication interface 12 decodes an electric signal received from another communication device 100 through the network 5 into data, and outputs the data to the processor 13.

The processor 13 includes a micro processing unit (MPU) to execute various programs stored in the memory 11 and implement various functions of the communication device 100A. The processor 13 further includes a detection timer 131 and a waiting timer 132.

The detection timer 131 is used to measure the down-state detection period. When receiving a master notification frame from a master, the processor 13 resets the detection timer 131, sets a value representing the down-state detection period included in the arbitration parameters 112 as a maximum measurement value to the detection timer 131, and then activates the detection timer 131.

The waiting timer 132 is used to measure the waiting period. When determining that a master is absent, the processor 13 transmits arbitration frames to other communication devices 100, resets the waiting timer 132, sets a value representing the waiting period included in the arbitration parameters 112 as a maximum measurement value to the waiting timer 132, and then activates the waiting timer 132.

As shown in FIG. 1, the communication device 100A includes, as functional components, a priority storage 110 for storing the priority of the communication device 100A, a down-state detection period storage 120 for storing the down-state detection period, a transmitter/receiver 130 for transmitting and receiving data to and from other communication devices 100, a master presence determiner 140 for determining the presence or absence of a master, a communication arbitrator 150 for performing communication arbitration with other communication devices 100, and an operation switch 160 for switching the operation of the communication device 100A to cause the communication device 100A to operate as a master.

The priority storage 110 stores the priority of the communication device 100A used in selecting a master and identification information for identifying the communication device 100A. The identification information uniquely identifies the communication device 100A. The identification information is, for example, a media access control (MAC) address assigned to the communication device 100A. The priority and identification information are tagged to arbitration frames transmitted by the communication arbitrator 150 (described later) to other communication devices 100. The priority storage 110 is an example of priority storage means according to the present disclosure. The functions of the priority storage 110 are implementable by the memory 11 shown in FIG. 2.

The down-state detection period storage 120 shown in FIG. 1 stores the down-state detection period for the communication device 100A to detect the absence of a master. As described above, the communication device 100A determines that a master is absent when not receiving a new master notification frame from a master before the down-state detection elapses.

Each communication device 100 has a different down-state detection period that is set shorter for a communication device 100 with a higher priority in selecting a master. For example, the communication devices 100A, 100B, and 100C operate as slaves with the communication device 100A with the highest priority and the communication device 100C with the lowest priority. In this case, the communication device 100A with the highest priority is set to have a shortest down-state detection period tA, and the communication device 100C with the third-highest priority is set to have a longest down-state detection period tC. The communication device 100B with the second-highest priority is set to have a down-state detection period tB longer than the down-state detection period tA and shorter than the down-state detection period tC.

The down-state detection period is set in this manner. The timings to detect the presence or absence of a master are thus defined in accordance with the order of the priorities. Thus, the communication device 100 with the highest priority is the first to detect that a master notification frame has not been received from a master. In the above example, the communication device 100A with the highest priority is the first to detect the presence or absence of a master. The down-state detection period storage 120 is an example of down-state detection period storage means according to the present disclosure. The functions of the down-state detection period storage 120 are implementable by the memory 11 shown in FIG. 2.

The transmitter/receiver 130 shown in FIG. 1 transmits and receives data to and from other communication devices 100. For example, the transmitter/receiver 130 receives a master notification frame from a master. When a master is absent, the transmitter/receiver 130 transmits an arbitration frame to other communication devices 100. The transmitter/receiver 130 receives an arbitration frame from any other communication device 100 that has determined that a master is absent. The functions of the transmitter/receiver 130 are implementable by the communication interface 12 shown in FIG. 2.

The master presence determiner 140 shown in FIG. 1 determines that a master is absent when not receiving a new master notification frame from a master after receiving a signal from a master and before the down-state detection elapses.

More specifically, in response to the transmitter/receiver 130 receiving a master notification frame, the master presence determiner 140 resets the detection timer 131 shown in FIG. 2, sets a value representing the down-state detection period included in the arbitration parameters 112 as the maximum measurement value to the detection timer 131, and then activates the detection timer 131. When the detection timer 131 reaches the set value, the master presence determiner 140 determines that a master is absent. As described above, the down-state detection period is set longer than the interval at which a master transmits a master notification frame. The detection timer 131 is reset at every reception of a master notification frame. Thus, the detection timer 131 reaching a set value indicates that a master has not transmitted a master notification frame. When determining that a master is absent, the master presence determiner 140 provides, to the communication arbitrator 150, information indicating that a master is absent. When the transmitter/receiver 130 receives a master notification frame before the detection timer 131 reaches a set value, the master presence determiner 140 determines that a master is present. In this case, the master presence determiner 140 resets the detection timer 131 and activates the detection timer 131. The master presence determiner 140 is an example of master presence determination means according to the present disclosure. The functions of the master presence determiner 140 are implementable by the processor 13 shown in FIG. 2.

The communication arbitrator 150 shown in FIG. 1 performs communication arbitration with other communication devices 100 by transmitting and receiving arbitration frames. When receiving, from the master presence determiner 140, information indicating that a master is absent, the communication arbitrator 150 provides, to other communication devices 100, information indicating that the communication device 100A is operable as a new master. More specifically, the communication arbitrator 150 transmits, to each of the other communication devices 100 through the transmitter/receiver 130, an arbitration frame tagged with the priority and identification information stored in the priority storage 110. After transmitting the arbitration frames to the other communication devices 100, the communication arbitrator 150 sets a value representing the waiting period included in the arbitration parameters 112 as the maximum measurement value to the waiting timer 132 shown in FIG. 2, and then activates the waiting timer 132. When the waiting timer 132 reaches the set value, the communication arbitrator 150 provides, to the operation switch 160 shown in FIG. 1, information instructing to perform switching to operating as a master.

When receiving an arbitration frame from any other communication device 100 through the transmitter/receiver 130, the communication arbitrator 150 performs the processing described below. The communication arbitrator 150 compares the priority tagged to the received arbitration frame with the priority of the communication device 100A stored in the priority storage 110. In other words, the communication arbitrator 150 determines which of the communication device 100A and the communication device 100 that has transmitted the received arbitration frame has a higher priority. When determining that the priority of the communication device 100A is higher than the priority tagged to the received arbitration frame, the communication arbitrator 150 transmits an arbitration frame tagged with the priority and identification information to each of the other communication devices 100 through the transmitter/receiver 130.

When the priority of the communication device 100A is lower than the priority tagged to the received arbitration frame, the communication device 100A continues to operate as a slave. In this case, when the communication arbitrator 150 has transmitted arbitration frames to other communication devices 100 before receiving the arbitration frame from the other communication devices 100, the communication arbitrator 150 stops the waiting timer 132. The communication device 100A can remain operating without switching to a master. The communication arbitrator 150 is an example of communication arbitration means according to the present disclosure. The functions of the communication arbitrator 150 are implementable by the processor 13 shown in FIG. 2.

After transmitting an arbitration frame, the communication arbitrator 150 waits until the waiting period elapses for the reason below. As described above, the down-state detection period is set shorter for a communication device 100 with a higher priority in selecting a master. The communication device 100 with the highest priority is thus the first to detect the absence of a master. In normal operation, the communication arbitrator 150 is not to wait after transmitting an arbitration frame. In an unexpected situation, a communication device 100 with the second-highest priority or lower may transmit an arbitration frame before an arbitration frame transmitted from a communication device 100 with the highest priority reaches the other communication devices 100. Thus, the communication arbitrator 150 waits after transmitting an arbitration frame.

In one example, the communication device 100A has the second-highest priority. In an unexpected situation, an arbitration frame transmitted from a communication device 100 with the highest priority may be delayed in reaching the communication device 100A for some reason. When the down-state detection period set for the communication device 100A elapses, the communication device 100A determines that a master is absent, transmits arbitration frames to other communication devices 100, and then waits until the waiting period elapses. When the communication device 100A receives, during the waiting period, the arbitration frame from the communication device 100 with the highest priority, the communication device 100A remains operating without switching to a master. In this manner, the communication arbitrator 150 that has transmitted an arbitration frame waits until the set waiting period elapses to prevent any communication device 100 not to operate as a master from switching to a master.

When receiving, from the communication arbitrator 150, information instructing to perform switching to operating as a master, the operation switch 160 shown in FIG. 1 switches, using the communication management parameters 113, the operation of the communication device 100A to cause the communication device 100A to operate as a master. For example, the communication device 100A that has started operating as a master reconnects the connections to other communication devices 100 operating as slaves, and transmits master notification frames to the other communication devices 100 at a predetermined timing. The functions of the operation switch 160 are implementable by the processor 13 shown in FIG. 2. The operation switch 160 is an example of operation switching means according to the present disclosure.

The processing performed for arbitration between the communication devices 100 will now be described. In one example, the communication device 100D shown in FIG. 1 operates as a master, and the communication devices 100A to 100C operate as slaves. The communication devices 100B and 100C operating as slaves have the same configuration as the communication device 100A described below.

The processor 13 included in the communication device 100A shown in FIG. 2 executes the arbitration program 111 stored in the memory 11 to perform the processing described below. When receiving a master notification frame from the communication device 100D operating as a master, the processor 13 resets the detection timer 131 and reactivates the detection timer 131.

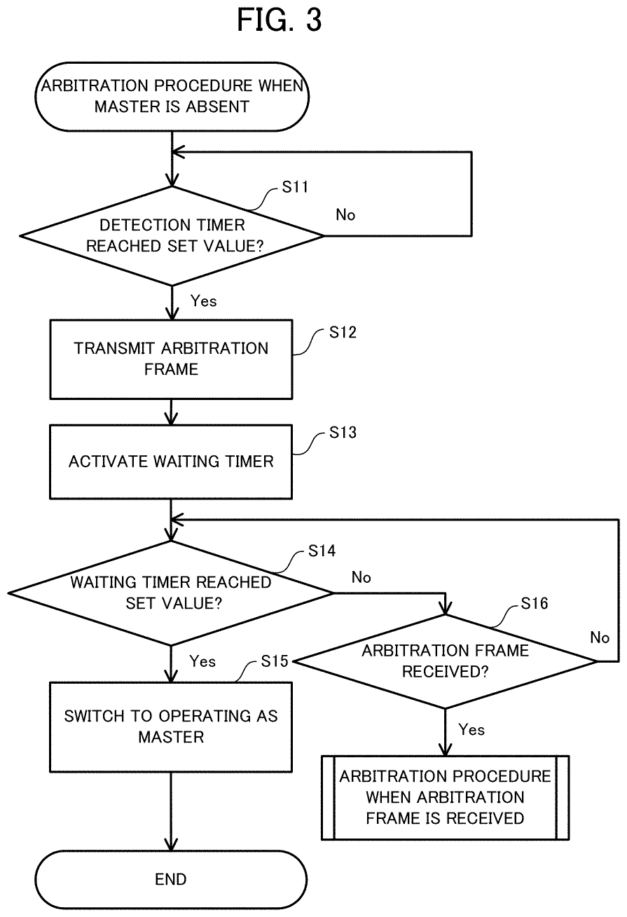

The arbitration procedure performed when a master is absent will now be described with reference to FIG. 3. As shown in FIG. 3, the processor 13 determines whether the detection timer 131 has reached a set value (step S11). When determining that the detection timer 131 has reached a set value (Yes in step S11), the processor 13 transmits arbitration frames to other communication devices 100 (step S12). More specifically, the processor 13 generates arbitration frames each tagged with the priority and identification information of the communication device 100A included in the arbitration parameters 112 stored in the memory 11, and outputs the generated arbitration frames to the communication interface 12. The communication interface 12 then broadcasts the arbitration frames. Thus, the arbitration frames are transmitted to the communication devices 100B and 100C through the network 5. The processor 13 activates the waiting timer 132 (step S13), and performs the processing in step S14.

When the waiting timer 132 reaches a set value (Yes in step S14) in step S14, the processor 13 starts operating as a master using the communication management parameters 113 shown in FIG. 2 (step S15).

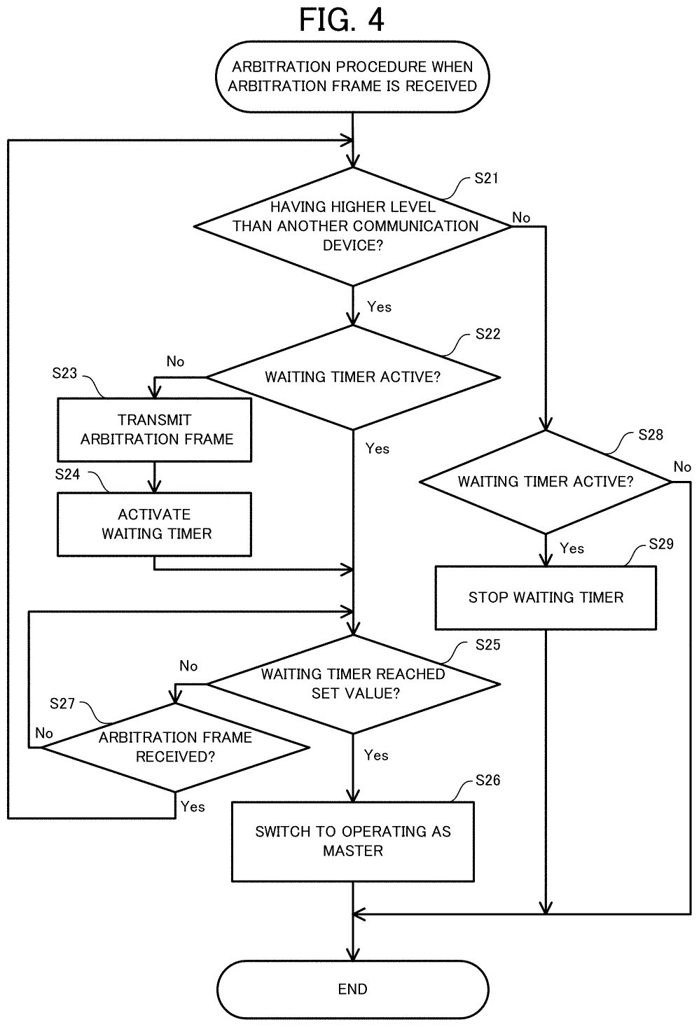

When the processor 13 receives an arbitration frame (Yes in step S16) from any other communication device 100 through the communication interface 12 before the waiting timer 132 reaches a set value (No in step S14), the processor 13 performs an arbitration procedure shown in FIG. 4 to be performed when an arbitration frame is received.

The processor 13 performs the procedure shown in FIG. 4 in the situation described below. The processor 13 included in the communication device 100A starts the procedure shown in FIG. 4 when the processor 13 that has transmitted arbitration frames in step S12 shown in FIG. 3 receives an arbitration frame from any other communication device 100 in step S16 shown in FIG. 3. The procedure responds to an unexpected situation in which a communication device 100 with the second-highest priority or lower transmits arbitration frames before the communication device 100 with the highest priority transmits arbitration frames. The processor 13 also starts the procedure shown in FIG. 4 when receiving an arbitration frame from any other communication device 100 before the detection timer 131 reaches a set value.

The processor 13 determines whether the priority of the communication device 100A included in the arbitration parameters 112 is higher than the priority tagged to the received arbitration frame (step S21). When determining that the communication device 100A has a higher priority (Yes in step S21), the processor 13 determines whether the waiting timer 132 is active (step S22).

When the waiting timer 132 is active (Yes in step S22), the processor 13 performs the processing in step S25. The waiting timer 132 being active indicates that the processor 13 has transmitted arbitration frames to the communication devices 100B and 100C.

When the waiting timer 132 is not active (No in step S22), the processor 13 transmits arbitration frames to the communication devices 100B and 100C (step S23). More specifically, the processor 13 reads, from the arbitration parameters 112 stored in the memory 11, the priority and the identification information of the communication device 100A, generates arbitration frames each tagged with the priority and identification information, and outputs the generated arbitration frames to the communication interface 12. The communication interface 12 then broadcasts the arbitration frames. The processor 13 activates the waiting timer 132 (step S24). The processor 13 then performs the processing in step S25.

When the waiting timer 132 reaches a set value in step S25 (Yes in step S25), the processor 13 starts operating as a master using the communication management parameters 113 shown in FIG. 2 (step S26). The processor 13 ends the arbitration procedure to be performed when an arbitration frame is received.

In step S25, the processor 13 determines whether the processor 13 has received an arbitration frame from any other communication device 100 through the communication interface 12 before the waiting timer 132 reaches a set value (No in step S25) (step S27). When determining that the processor 13 has received an arbitration frame from any other communication device 100 (Yes in step S27), the processor 13 repeats the processing in step S21.

When determining that the priority of the communication device 100A included in the arbitration parameters 112 is lower than the priority tagged to the received arbitration frame in step S21 (No instep S21), the processor 13 determines whether the waiting timer 132 is active (step S28).

When the waiting timer 132 is active (Yes in step S28), the processor 13 stops the waiting timer 132 (step S29). The communication device 100A that has received an arbitration frame from a communication device 100 with a priority higher than the priority of the communication device 100A is not to operate as a master. The processor 13 then ends the arbitration procedure to be performed when an arbitration frame is received. When the waiting timer 132 is not active (No in step S28), the processor 13 ends the arbitration procedure to be performed when an arbitration frame is received.

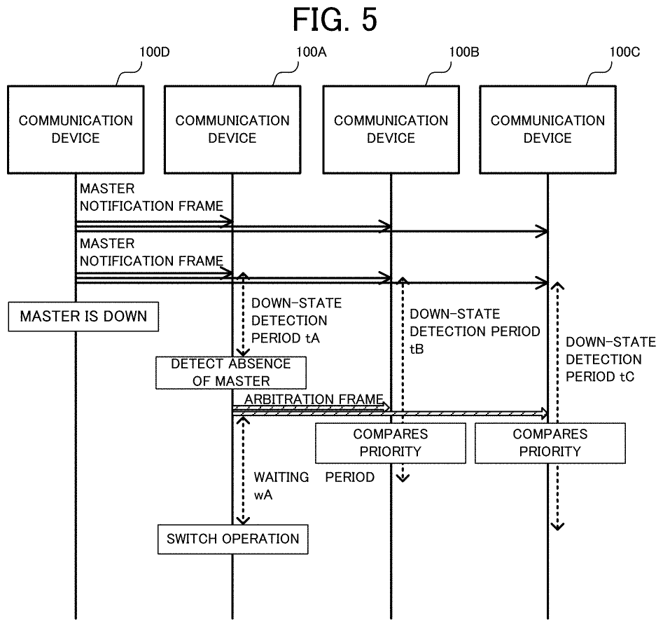

As described above, in the configuration according to the embodiment, the down-state detection period for each communication device 100 operating as a slave is set shorter for a communication device 100 with a higher priority. When the down-state detection period set in accordance with the priority elapses, each communication device determines whether a master is present. In one example, as shown in FIG. 5, the communication devices 100A, 100B, and 100C operate as slaves, and the communication device 100D operates as a master. The priority is set lower in the order of the communication devices 100A, 100B, and 100C with the communication device 100A with the highest priority. The down-state detection period is set longer in the order of the down-state detection period to for the communication device 100A, the down-state detection period tB for the communication device 100B, and the down-state detection period tC for the communication device 100C.

In this case, the communication device 100A with the shortest down-state detection period to is the first to detect the absence of a master. Thus, the communication device 100A with the highest priority is the first to transmit arbitration frames to other communication devices 100. The communication devices 100B and 100C each compare the priority tagged to the master notification frame received from the communication device 100A with the preassigned priorities. The communication devices 100B and 100C each with the priority lower than the priority tagged to the arbitration frame received from the communication device 100A perform no further action. The communication device 100A that has transmitted arbitration frames starts operating as a master when a waiting period wA elapses.

In the example shown in FIG. 5, the communication device 100A with the highest priority alone transmits arbitration frames, and the communication devices 100B and 100C transmit no arbitration frames. This shortens the time taken to transmit and receive arbitration frames between the communication devices 100, thus shortening the time taken to select a new master.

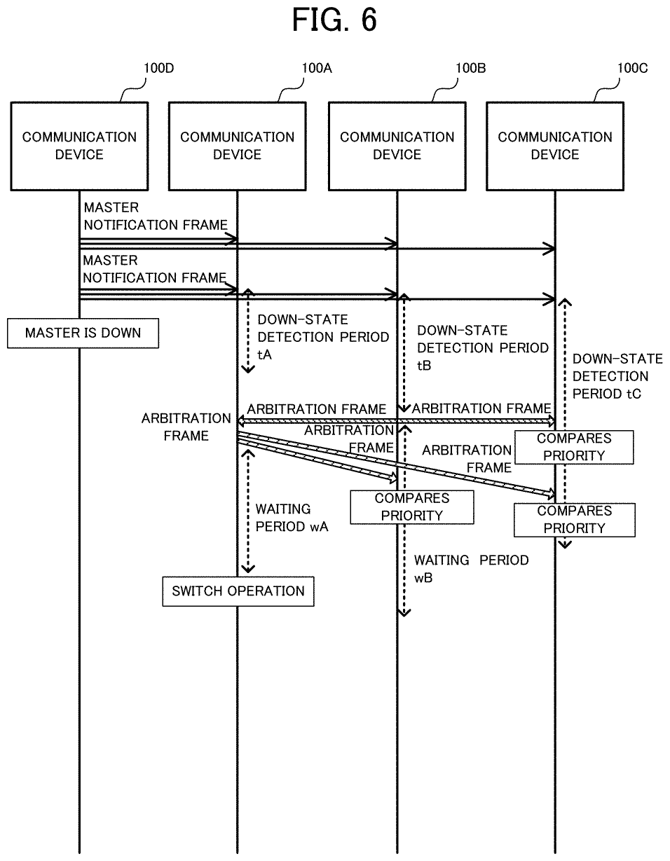

As shown in FIG. 6, arbitration frames transmitted from the communication device 100A with the highest priority may be delayed in reaching the communication devices 100B and 100C for some reason. In the illustrated example, arbitration frames transmitted from the communication device 100B with the second-highest priority have reached the communication devices 100A and 100C before arbitration frames transmitted from the communication device 100A reach the communication devices 100B and 100C.

In this case, the communication device 100B that has transmitted the arbitration frames activates the waiting timer 132 and waits until a waiting period wB elapses. The communication device 100B receives an arbitration frame from the communication device 100A before the waiting period wB elapses. The communication device 100B compares the priority tagged to the arbitration frame received from the communication device 100A with the priority of the communication device 100B. The communication device 100B with a lower priority than the communication device 100A stops the waiting timer 132. In this case, the communication device 100B does not switch to a master.

The communication device 100C compares the priority tagged to the arbitration frame received from the communication device 100B with the priority of the communication device 100C. The communication device 100C with a lower priority than the communication device 100B performs no further action. Further, the communication device 100C compares the priority tagged to the arbitration frame received from the communication device 100A with the priority of the communication device 100C. The communication device 100C with a lower priority than the communication device 100A performs no further action.

The communication device 100A receives, from the communication device 100B, an arbitration frame tagged with a priority lower than the priority of the communication device 100A. The communication device 100A with a higher priority thus transmits arbitration frames to the communication devices 100B and 100C. The communication device 100A starts operating as a master when the waiting period wA elapses. In the example shown in FIG. 6, not all the communication devices transmit arbitration frames. This shortens the time taken to select a new master although the time is slightly longer than the time taken in the example shown in FIG. 5.

In the configuration according to the embodiment, each slave has a different down-state detection period, or time intervals at which each slave determines whether a master is present, in accordance with the priority of the slave. This prevents most of the slaves with lower priorities from transmitting arbitration frames. This configuration more effectively shortens the time taken to select a master from a larger number of slaves. The priority of the communication device 100A is an example of a first level according to the present disclosure, and the priority of the communication device 100B is an example of a second level according to the present disclosure.

Modification 1

In the embodiment, a user managing the communication system 1 uses a setting tool to register the priorities and the down-state detection periods as the arbitration parameters 112 shown in FIG. 2 with the memory 11. However, the priorities may be determined automatically. The components different from the components described in the embodiment will now be described mainly.

In one example, the communication device 100D shown in FIG. 1 operates as a master, and the communication devices 100A to 100C operate as slaves. For example, immediately after establishing connections, the communication device 100D operating as a master requests identification information from each of the communication devices 100A to 100C. The communication devices 100A to 100C each transmit identification information stored in each memory 11 to the communication device 100D operating as a master. Based on the determination that a MAC address of a larger value has a higher priority, the master determines the priority and the down-state detection period for each of the communication devices 100A to 100C operating as slaves. The master then transmits the determined priorities and the down-state detection periods to the communication devices 100A to 100C.

The master determines the down-state detection periods in accordance with the priorities. More specifically, the master determines each down-state detection period by multiplying the priority by a reference period predetermined for the priority.

In one example, the reference period is 100 milliseconds. A communication device with the highest priority is determined to have a down-state detection period of 1×100 milliseconds=100 milliseconds. A communication device with the second-highest priority is determined to have a down-state detection period of 2×100 milliseconds=200 milliseconds. The master transmits the determined priorities and the down-state detection periods to each of the communication devices 100B to 100D. Thus, each of the communication devices 100B to 100D operating as a slave stores the priority and the down-state detection period received from the master as the arbitration parameters shown in FIG. 2 into the memory 11.

Modification 2

In the above example, each of the communication devices 100A to 100C operating as a slave has the configuration shown in FIGS. 1 and 2 to be operable as a master. However, one or more communication devices preselected from the communication devices 100 operating as slaves may detect the down-state of a master and operate as a master.

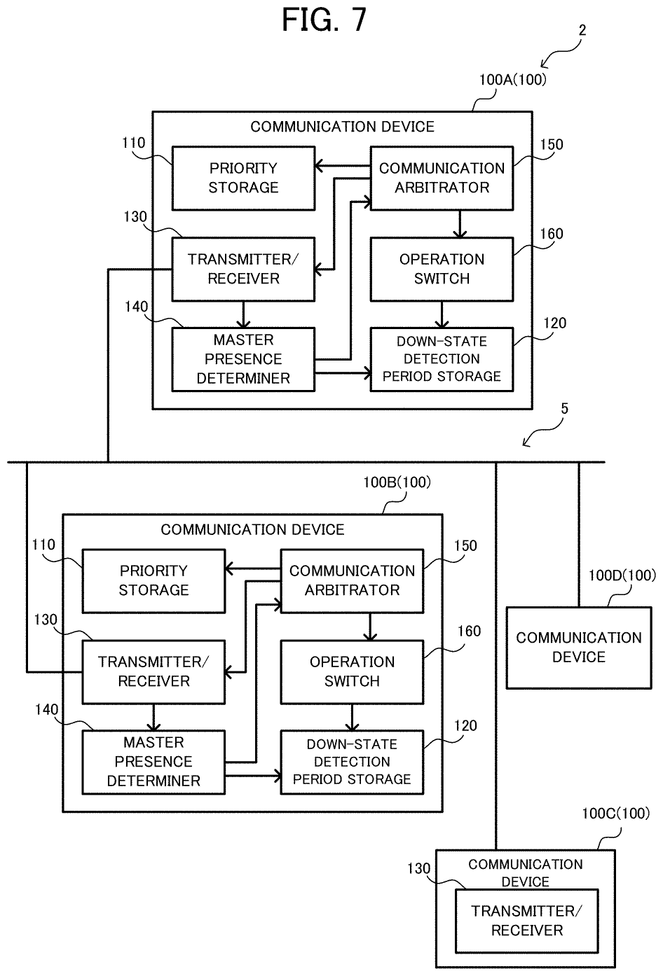

In a communication system 2 according to Modification 2 shown in FIG. 7, the communication devices 100A and 100B are set to be operable as a master. In other words, the communication devices 100A and 100B are set as candidates for a master. The communication device 100C is not set as a candidate for a master. The communication device 100D is set to operate as a master. The communication devices 100A and 100B include the components shown in FIGS. 1 and 2 as described in the embodiment. The communication devices 100A and 100B detect the down-state of a master and perform communication arbitration.

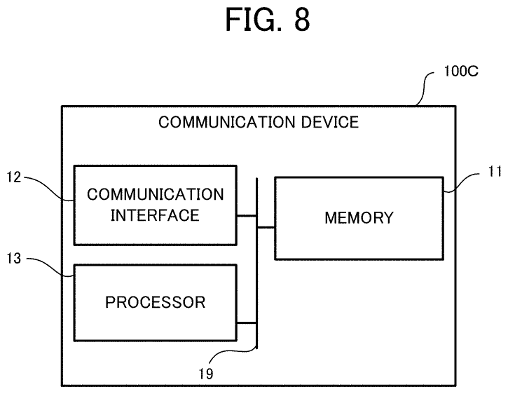

The communication device 100C simply includes, as a functional component, the transmitter/receiver 130 for receiving arbitration frames. The communication device 100C neither detects the down-state of a master nor compares the priorities tagged to arbitration frames. As shown in FIG. 8, the communication device 100C eliminates hardware components in the memory 11, or specifically eliminates the arbitration program 111 for performing communication arbitration between communication devices 100, the arbitration parameters 112 used for communication arbitration, and the communication management parameters 113 for managing communication through the network 5. The processor 13 included in the communication device 100C may eliminate the detection timer 131 and the waiting timer 132. In this manner, any slaves not to be selected as a master can have a simpler hardware configuration. For example, a communication device 100 with higher processing capability may be operate as a master, rather than a communication device 100 with lower processing capability. Thus, any communication devices 100 with lower processing capability may be excluded from candidates for a master.

Although the configurations according to the embodiment and Modifications 1 and 2 have been described above, the present disclosure is not limited to the above examples. For example, a master may request, from each of the communication devices 100 operating as slaves, the Internet Protocol (IP) address or the station number on the network 5 as identification information, instead of the MAC address. A master may determine that a communication device with a smaller value representing identification information has a higher priority.

In the example according to the embodiment, the waiting period, for which a communication device 100 waits after transmitting arbitration frames, is set shorter for a communication device 100 with a higher priority. However, the waiting period may be set differently. For example, all the communication devices 100 may have the same length of the waiting period.

The programs described above may be stored in a non-transitory computer-readable recording medium, such as a magnetic disk, an optical disc, a magneto-optical disc, a flash memory, a semiconductor memory, or a magnetic tape.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

tA, tB, tC Down-state detection period
wA Waiting period
1 Communication system
5 Network
11 Memory
12 Communication interface
13 Processor
19 Bus
100, 100A, 100B, 100C, 100D Communication device
110 Priority storage
111 Arbitration program
112 Arbitration parameter
113 Communication management parameter
120 Down-state detection period storage
130 Transmitter/receiver
131 Detection timer
132 Waiting timer
140 Master presence determiner
150 Communication arbitrator
160 Operation switch

1. A master-slave communication system comprising:
communication devices each operable as a master or a slave, wherein
each of at least two of the communication devices that operate as the slaves includes
a priority storage to store a priority in selecting as a new master a communication device among the communication devices that operate as the slaves,
a detection period storage to store a down-state detection period set shorter for the higher priority,
a master presence determiner to determine whether the communication device that operates as the master is present based on whether the communication device receives, after receiving a signal from the communication device that operates as the master and before the down-state detection period elapses, a new signal from a communication device that operates as the master,
a communication arbitrator to notify, to another communication device, a first level as the priority of the communication device
when the master presence determiner determines that the communication device that operates as the master is absent, and
an operation switcher to switch an operation of the communication device to an operation as the master when a waiting period elapses after the communication arbitrator notifies the first level to the another communication device, wherein
the communication device that operates as the master collects, from each of the communication devices that operate as the slaves, identification information that uniquely identifies the communication device, determines the priority from the collected identification information, determines the down-state detection period corresponding to the priority, and transmits the priority and the down-state detection period to the communication devices that operate as the slaves, and
upon reception of the priority and the down-state detection period from the communication device that operates as the master, the communication devices that operate as the slaves store the priority in the priority storage and store the down-state detection period in the detection period storage.

2. (canceled)

3. The communication system according to claim 1, wherein
when a second level that is the priority of the another communication device is notified by the another communication device before the communication arbitrator notifies the first level to the another communication device, the communication arbitrator determines whether the first level is higher than the second level, and
when determining that the first level is higher than the second level, the communication arbitrator notifies, to the another communication device, the first level as the priority of the communication device.

4. The communication system according to claim 1, wherein
when the second level that is the priority of the another communication device is notified by the another communication device during the waiting period, the communication arbitrator determines whether the first level is higher than the second level, and
when the communication arbitrator determines that the first level is lower than the second level, the operation switcher does not switch from the operation as a slave to the operation as a master after the waiting period elapses.

5. A master-slave communication device comprising:
a priority storage to store a priority in selecting as a new master a communication device among the communication devices that operate as slaves;
a detection period storage to store a down-state detection period set shorter for the higher priority;
a master presence determiner to determine whether the master is present based on whether the communication device receives, after receiving a signal from the master and before the down-state detection period elapses, a new signal from the master;
a communication arbitrator to notify, to another communication device, a first level as the priority of the communication device when the master presence determiner determines that the master is absent; and
an operation switcher to switch an operation of the communication device to an operation as the master when a waiting period elapses after the communication arbitrator notifies the first level to the another communication device, wherein
the priority is determined by the master based on identification information collected from each of the communication devices that operate as the slaves, the identification information uniquely identifying a communication device that operates as the slave, and the down-state detection period is determined by the master in accordance with the priority, and
upon reception of the priority and the down-state detection period from the master, the communication device stores the priority in the priority storage and stores the down-state detection period in the detection period storage.

6. (canceled)

7. A non-transitory computer-readable recording medium storing a program for causing a computer operable as a slave in a master-slave communication system to perform operations comprising:
storing a priority in selecting as a new master the computer among slaves, the priority being determined from identification information of the computer that operates as the slave;
storing a down-state detection period set shorter for the higher priority;
determining whether the master is present based on whether the computer receives, after receiving a signal from the master and before the down-state detection period elapses, a new signal from the master;
notifying, to another computer that operates as the slave, a first level as the priority of the computer when the master is determined to be absent; and
switching an operation of the computer to an operation as the master when a waiting period elapses after notifying the first level to the another computer, wherein
the priority and the down-state detection period are determined by the master and supplied from the master to the computer that operates as the slave.

8. The communication system according to claim 1, wherein
the waiting time is set to be shorter for the higher priority.
